(19) United States
(12) Patent Application Publication
(10) Pub. No.: US 2020/0125116 A1
(43) Pub. Date: Apr. 23, 2020

(54) MOVEMENT CONTROL METHOD AND SYSTEM THEREOF FOR MULTIPLE ROBOTS

(71) Applicant: Quanta Computer Inc., Taoyuan City (TW)

(72) Inventors: Yang-Sheng WANG, Taoyuan City (TW); Tao-Chih HSU, Taoyuan City (TW); Yao-Hsuan CHIANG, Taoyuan City (TW); Yu-Ching CHEN, Taoyuan City (TW); Yo-Hsiang CHANG, Taoyuan City (TW)

(21) Appl. No.: 16/435,636

(22) Filed: Jun. 10, 2019

(30) Foreign Application Priority Data
Oct. 19, 2018 (TW) 107136965

(51) Int. Cl. G05D 1/02; B25J 9/16; B25J 11/00

(52) U.S. Cl. CPC G05D 1/0289; B25J 11/0085; B25J 9/1666

(57) ABSTRACT

A movement control method for multiple robots, including: obtaining a first operating status and a first predicted moving path corresponding to a first robot; obtaining a second operating status and a second predicted moving path corresponding to a second robot; determining whether the first predicted moving path and the second moving path have overlapping segments or adjacent segments; in response to the first predicted moving path and the second moving path having overlapping segments or adjacent segments, determining whether the difference between the first prediction time of the first robot and the second prediction time of the second robot is less than a given time; and in response to the difference being less than the given time, changing a first moving status of the first robot or a second moving status of the second robot according to the first operating status and the second operating status.

### CROSS REFERENCE TO RELATED APPLICATIONS

This application claims priority of Taiwan Patent Application No. 107136965, filed on Oct. 19, 2018, the entirety of which is incorporated by reference herein.

### BACKGROUND OF THE INVENTION

### Field of the Invention

The present invention relates to a movement control method and system thereof for multiple robots.

### Description of the Related Art

With the advancement of technology, the application of robots in life has been quite extensive. In response to multiple robots performing tasks in the same space simultaneously, the conventional technique involves determining whether two robots might collide by use of a laser, optical lens, or detecting signal strength. However, collisions may still occur, since the laser or the optical lens have dead corners or blind spots, and the determination of signal strength may not accurately detect the real position of the robot. Therefore, how to implement a dodging strategy in advance before a collision occurs is the problem that currently needs to be solved.

### BRIEF SUMMARY OF THE INVENTION

An embodiment of the present invention provides a movement control method for multiple robots, including: obtaining a first operating status and a first predicted moving path corresponding to a first robot; obtaining a second operating status and a second predicted moving path corresponding to a second robot; determining whether the first predicted moving path and the second predicted moving path have overlapping segments or adjacent segments; in response to the first predicted moving path and the second predicted moving path having the overlapping segments or the adjacent segments, determining whether a difference between a first prediction time of the first robot and a second prediction time of the second robot, corresponding to the overlapping segments or the adjacent segments, is less than a given time; and in response to the difference between the first prediction time and the second prediction time being less than the given time, changing a first movement status of the first robot or a second movement status of the second robot according to the first operating status and the second operating status.

Another embodiment of the present invention provides a movement control system for multiple robots, including a control terminal and a plurality of robots. The control terminal includes a first storage unit and a first processing unit. The first storage unit stores a task map. The first processing unit is configured to divide the task map into a plurality of task regions, assign the plurality of task regions to the plurality of robots and determine whether two of the robots have overlapping segments or adjacent segments according to an operating status and a predicted moving path of each of the robots. In response to the two robots having the overlapping segments or the adjacent segments, the first processing unit further determines whether a difference between respective prediction time of the two robots corresponding to the overlapping segments or the adjacent segments is less than a given time. And, in response to the difference between the respective prediction time of the two robots being less than the given time, the first processing unit outputs a control signal to change a movement status of one of the robots according to the operating statuses of the two robots. Each robot includes a second storage unit and a second processing unit. The second storage unit is configured to store the task region received from the control terminal. The second processing unit is configured to determine the operating status according to the task map, generate the predicted moving path, and change the movement status according to the control signal.

According to one embodiment of the present invention, wherein in response to the first operating status and the second operating status being both moving across regions, temporarily stopping the first robot or the second robot, corresponding to the later of the first prediction time and the second prediction time, in front of a starting point of the overlapping segments or the adjacent segments when reaching the overlapping segments or the adjacent segments, and wherein the moving across regions is moving from one task region to another.

According to another embodiment of the present invention, wherein in response to the first predicted moving path of the first robot or the second predicted moving path of the second robot, corresponding to the later of the first prediction time and the second prediction time, has been blocked, changing the first predicted moving path or the second predicted moving path.

According to another embodiment of the present invention, wherein in response to the first operating status and the second operating status are performing a cleaning task, temporarily stopping the first robot or the second robot, corresponding to the later of the first prediction time and the second prediction time, in front of a starting point of the overlapping segments or the adjacent segments when reaching the overlapping segments or the adjacent segments.

According to another embodiment of the present invention, wherein in response to the first operating status being moving across regions and the second operating status being performing a cleaning task, the first robot changes the first predicted moving path, changes a next task region of the first robot or temporarily stops in front of a starting point of the overlapping segments or the adjacent segments when reaching the overlapping segments or the adjacent segments.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a system architecture diagram illustrating a movement control system for multiple robots in accordance with an embodiment of the present invention.

FIG. 2 is a system architecture diagram illustrating a movement control system for multiple robots in accordance with another embodiment of the present invention.

FIG. 3A to FIG. 3C are schematic diagrams illustrating a predicted moving path of robot in accordance with some embodiments of the present invention.

FIG. 4A to FIG. 4D are schematic diagrams illustrating a dodging strategy of a robot in accordance with an embodiment of the present invention.

FIG. 5A to FIG. 5D are schematic diagrams illustrating a dodging strategy of a robot in accordance with another embodiment of the present invention.

FIG. 6 is a schematic diagram illustrating a dodging strategy of a robot in accordance with another embodiment of the present invention.

FIG. 7A to FIG. 7B are flowcharts illustrating a movement control method for multiple robots in accordance with an embodiment of the present invention.

### DETAILED DESCRIPTION OF THE INVENTION

Further scopes to which the present movement control method and system thereof for multiple robots can be applied will become apparent from the detailed description provided herein. It should be understood that the detailed description and specific examples, while indicating exemplary embodiments of a movement control method and system thereof for multiple robots, are intended for the purpose of illustration only and not intended to limit the scope of the present invention.

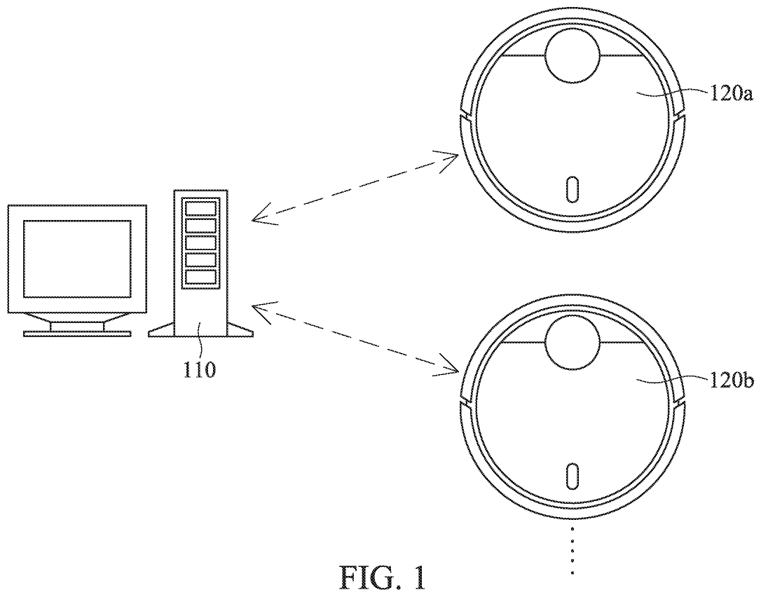

FIG. 1 is a system architecture diagram illustrating a task region assigning system for robots in accordance with the present invention. The task region assigning system can include a control terminal 110 and a plurality of robots 120a-120n. The control terminal 110 can be implemented in an electronic device such as a desktop computer, a notebook computer, a tablet computer or a smart phone etc., and at least includes a first processing unit, a first storage unit and a first communication interface. The first processing unit can be implemented through multiple manners, such as dedicated hardware circuits or general purpose hardware (e.g., single processor, multiprocessor capable of parallel computations, graphics processor or other processors capable of computation), and provide the functions described hereinafter when executing codes or software. The first storage unit is configured to store at least one task map and the information related to the tasks, for the first processing unit to access when executing the related computations. The first storage unit can be a non-volatile storage device such as a hard disk, a flash memory, ROM etc. Moreover, the first communication interface can be a wireless communication interface (not shown), the wireless communication interface can be a LAN (local area network) communication module, a WLAN (wireless local area network) communication module or a Bluetooth communication module etc., for exchanging various signals and data with the robots 120a-120n. In one specific embodiment, the robots 120a-120n are sweeping robots or other cleaning devices that can perform cleaning tasks according to instructions.

Each of the robots 120a-120n at least includes a second processing unit, a second storage unit and a second communication interface. Similarly, the second processing unit can be implemented through multiple manners, such as dedicated hardware circuits or general purpose hardware, and provide the functions described hereinafter when executing codes or software. The second storage unit can be a non-volatile storage device such as a hard disk, a flash memory, ROM etc. for storing the task map and/or instructions and information related to cleaning task received from the control terminal 110 through the second communication interface. The second processing unit is configured to drive motor according to the received task map to cause the robot performing cleaning task, or perform the calculations related to the cleaning task (e.g., determine a predicted moving path and calculate a corresponding prediction time to each position of the predicted moving path).

According to an embodiment of the present invention, after each robot 120a-120n is activated, each robot 120a-120n transmits its own position in the task map to the control terminal 110 at first. The position on the task map of each robot 120a-120n can be obtained by the following manner, for example, inputting the position (e.g., coordinates or relative position) of each robot 120a-120n by the user, placing each robot 120a-120n at the starting point of the next task region according to the position of the task region directly, or performing positioning and the like in the task map by SLAM (simultaneous localization and mapping) manner through at least one sensor built in the robots 120a-120n, but the present invention is not limited thereto. While obtaining the position of each robot 120a-120n in the task map, the control terminal 110 then transmits the task regions to each robot 120a-120n through the first communication, such that each robot 120a-120n can determine the corresponding predicted moving path according to the received task region and generate corresponding prediction time of each position in the predicted moving path. After completing the calculation of the predicted moving path and the prediction time, each robot 120a-120n will transmit the predicted moving path and the prediction time to the control terminal 110 through the second communication interface for the control terminal 110 to determine whether the predicted moving paths between robots have overlapping segments or adjacent segments, and in response to the control terminal 110 determining there are overlapping segments or adjacent segments between two robots, the control terminal 110 will transmit a control signal to change the movement statuses of the robots 120a-120n.

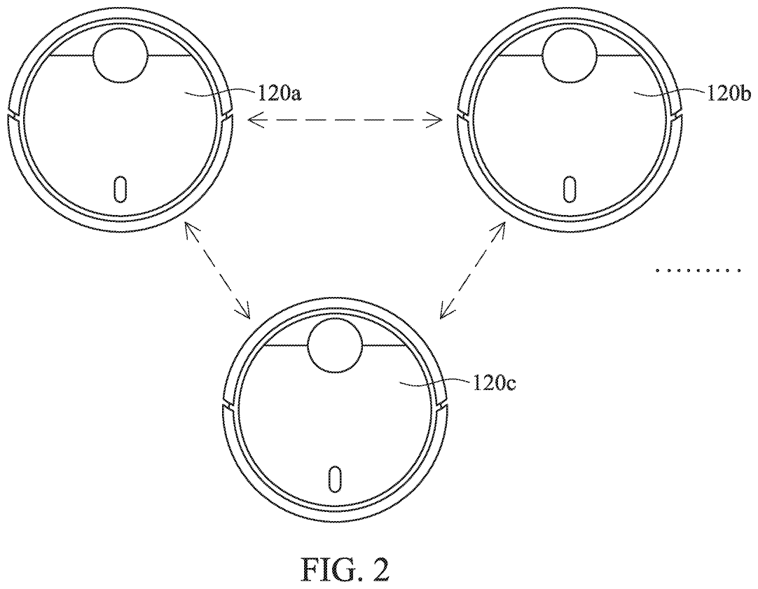

FIG. 2 is a system architecture diagram illustrating a movement control system for multiple robots in accordance with another embodiment of the present invention. Each robot 120a-120n includes at least a second processing unit, a second storage unit and a second communication interface. Similarly, the configurations of the second processing unit, the second storage unit and the second communication interface are as described above, and will not be described here to simplify the description. Moreover, one of the robots 120a-120n will be set as a leader, while the leader robot will divide the task map into multiple task regions and assign the task regions to the other robots, so that each robot 120a-120n can calculate a corresponding predicted moving path and corresponding prediction time of each position in the predicted moving path. After completing the calculation of the predicted moving path and the prediction time, each robot 120a-120n will transmit the predicted moving path and the prediction time to the other robots through the second communication interface, so that each robot 120a-120n can determine subsequent actions according to the operating status, the predicted moving path and the prediction time corresponding to the other robots when the predicted moving path is overlapped with or adjacent to the predicted moving path of the other robots.

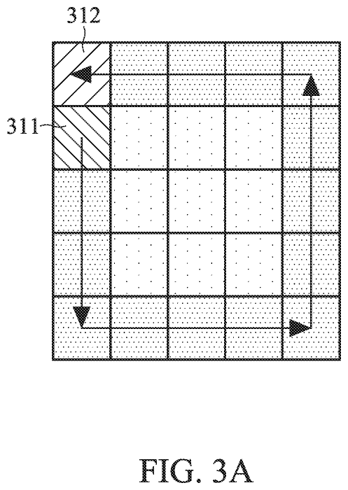

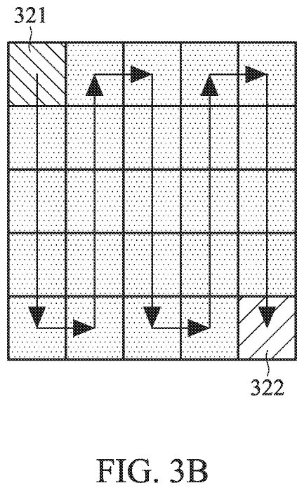

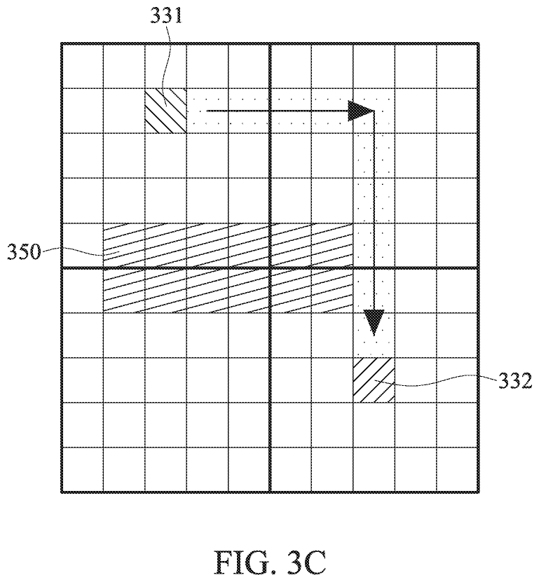

FIG. 3A to FIG. 3C are schematic diagrams illustrating a predicted moving path of robot in accordance with some embodiments of the present invention. In some embodiments of the present invention, in response to the operating status of the robot being performing the cleaning task, the robot can move in the task region by using a Wall Following behavioral mode or a Boustrophedon mode. For example, FIG. 3A is a schematic diagram illustrating the Wall Following behavioral mode. As shown in the figure, a moving starting point of the robot is the grid 311 and the moving terminal point is the grid 312, while the robot moves along the edges of the task region as indicated by the arrow in the figure. In response to the robot encountering an obstacle, the robot will also move along the edges of the obstacle.

FIG. 3B is a schematic diagram illustrating the Boustrophedon mode. As shown in the figure, a moving starting point of the robot is the grid 321 and the moving terminal point is the grid 322, while the robot will move backward and forward as indicated by the arrow in the figure to clean the entire task region.

FIG. 3C is a schematic diagram illustrating a moving path of moving across regions. When moving across the regions, the robot will reach the next task region with the fewest times of turnings. For example, in response to the robot moving from the grid 331 to the grid 322, the moving path indicated by the arrow in the figure is the path that can avoid the obstacle 350, turn the fewest times and have the shortest moving distance.

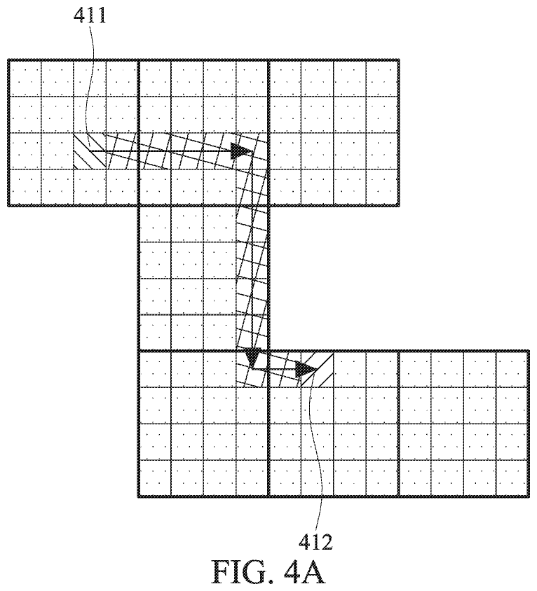

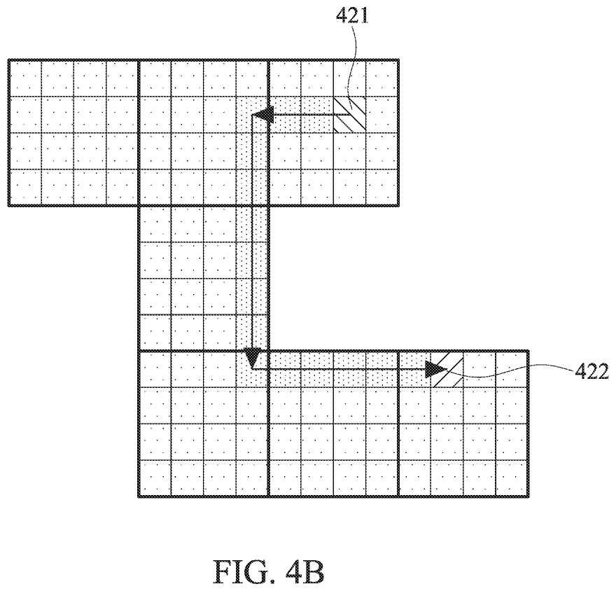

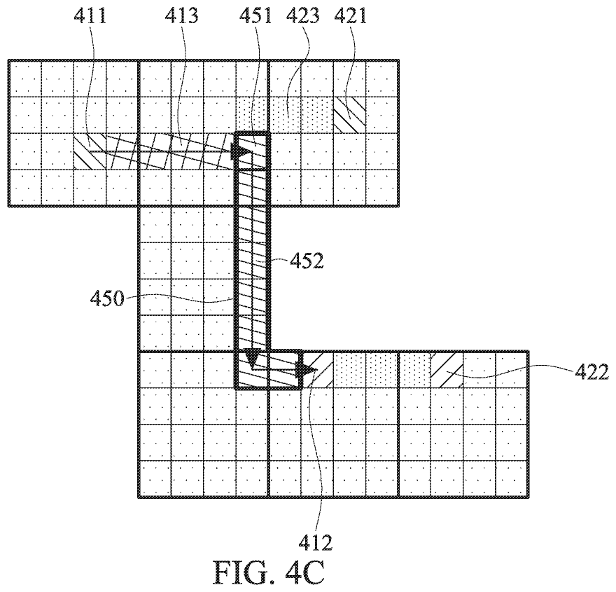

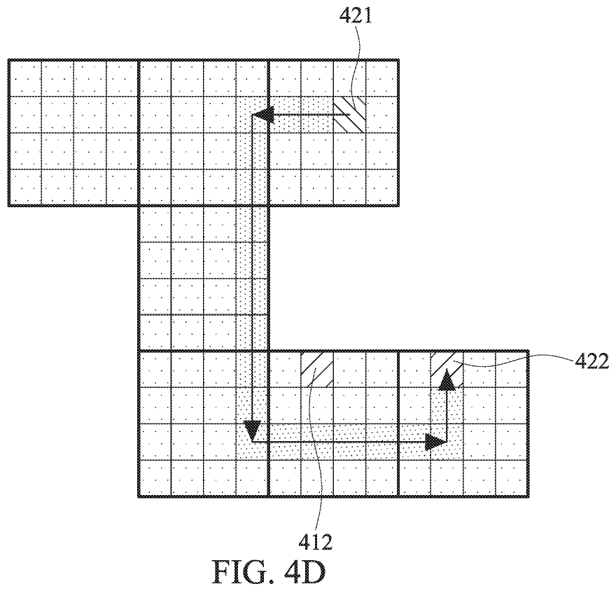

FIG. 4A to FIG. 4D are schematic diagrams illustrating a dodging strategy of robot in accordance with an embodiment of the present invention. In this embodiment, the operating statuses of two robots are both moving across regions. The moving across regions refers to the action that the robot has completed the cleaning task of the current task region and moves to the next task region from the current task region. As shown in FIG. 4A, the grid 411 is the moving starting point of the first robot, and the grid 412 is the moving terminal point of the first robot, while the arrow indicated in the figure is the predicted moving path of the first robot. Please refer to FIG. 4B, in FIG. 4B, the grid 421 is the moving starting point of the second robot, and the grid 422 is the moving terminal point of the second robot, while the arrow indicated in the figure is the predicted moving path of the second robot. Refer with the content of FIG. 4A and FIG. 4B, the region 450 in FIG. 4C is the overlapping segments of the predicted moving paths of the first robot and the second robot. The control terminal 110 or the leader robot would further determine whether the first robot will collide with the second robot according to the respective prediction time that the first robot and the second robot entering the region 450 (i.e., the respective prediction time that the first robot and the second robot move to the grid 451 shown in FIG. 4C).

According to an embodiment of the present invention, in response to the first robot reaching the grid 451 later than the second robot, and when the time difference between these two robots reaching the grid 451 is less than a given time (in a specific embodiment, when the speed of the robot is 20 cm/s, the given time is, for example, 5 seconds or a range from 5 seconds to 10 seconds), the first robot will temporarily stop in front of the grid 451 (e.g., stop at the position of grid 413 shown in FIG. 4C), until the second robot has left the region 450 or entered the region 450 for a specific time (e.g., reaches the position of grid 452), the first robot then enters the region 450 and moves to the position of the moving terminal point 412.

According to another embodiment of the present invention, in response to the second robot reaching the grid 451 later than the first robot, and when the time difference between these two robots reaching the grid 451 is less than the given time, the second robot will temporarily stop in front of the grid 451 (e.g., stop at the position of grid 423 shown in FIG. 4C), until the first robot has left the region 450 or entered the region 450 for a specific time (e.g., reaches the position of grid 452), the second robot then enters the region 450.

However, as shown in the figure, the moving terminal point 412 of the first robot is located on the predicted moving path of the second robot, and if the first robot reaches to the moving terminal point 412 first, the predicted moving path of the second robot would be obstructed. Thus, the second processing unit of the second robot would re-determine a new predicted moving path (as the arrow shown in FIG. 4D) to avoid colliding with the first robot.

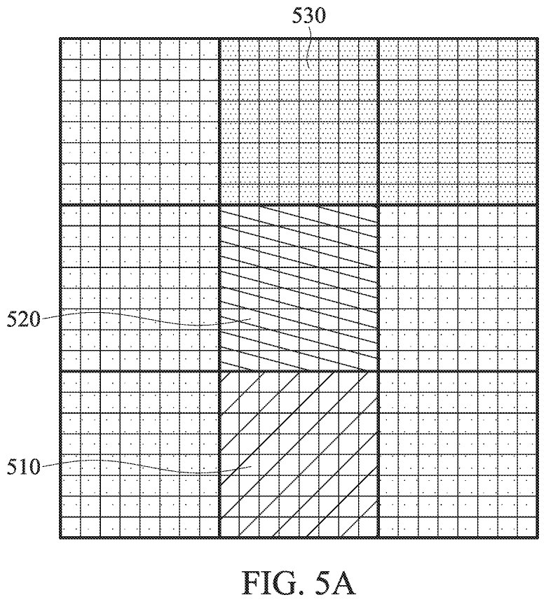

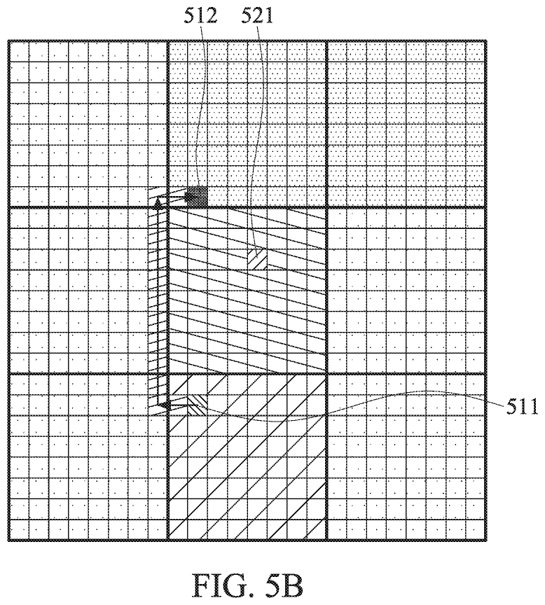

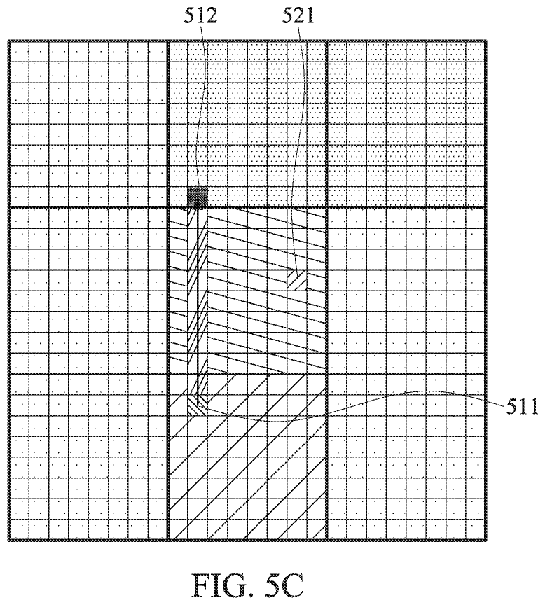

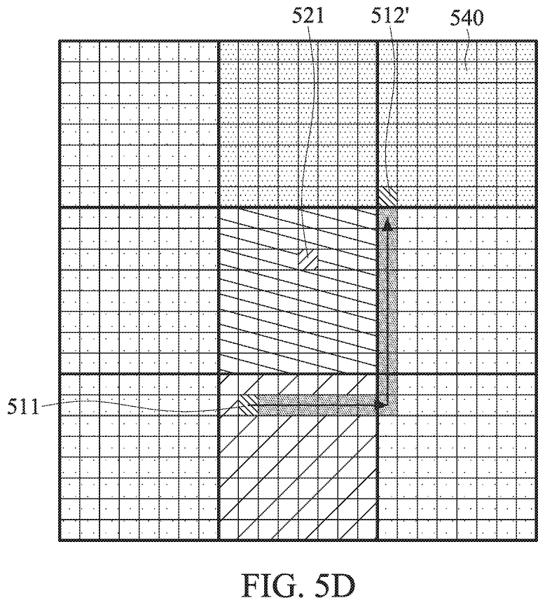

FIG. 5A to FIG. 5D are schematic diagrams illustrating a dodging strategy of robot in accordance with another embodiment of the present invention. In this embodiment, the operating status of the first robot is moving across regions, and the operating status of the second robot is performing the cleaning task. As shown in FIG. 5A, the first robot intends to move from the task region 510 to the task region 530, and the second robot is performing the cleaning task in the task region 520. In the embodiment of the present invention, in order to avoid any decline in the efficiency of the robot's performance of the cleaning task, in response to the predicted moving path of the robot performing the cleaning task and the predicted moving path of the robot moving across the regions have overlapping segments, the robot performing the cleaning task has a higher priority than the robot moving across the regions. In other words, the robot moving across the regions must have the robot performing the cleaning task completing the cleaning task in priority. Therefore, in an embodiment of the present invention, as shown in FIG. 5B, the first robot changes its predicted moving path to bypass the task region 520 while not cross the task region 520, so as to avoid affecting the second robot as it performs the cleaning task.

According to another embodiment of the present invention, the first robot can also avoid the region which being cleaned by the second robot according to the predicted moving path and the prediction time of the second robot, so as to avoid colliding with the second robot. For example, as shown in FIG. 5C, in response to the second robot is cleaning the area in the right-half side of the task region 520 (e.g., the second robot is at the position of grid 521 currently), the first robot can choose to pass through the predicted moving path in the left-half side of the task region 520 directly (as the arrow shown in figure), since the left-half side of the task region 520 still has enough space for the first robot to move.

Alternatively, according to another embodiment of the present invention, in response to the first robot has other uncompleted task regions (e.g., as the task region 540 shown in FIG. 5D), since the shortest moving distance of the first robot from task region 510 to the task region 540 does not pass through the task region 520, the first robot can also choose to change the next task region from the task region 530 to the task region 540 (move to the position of grid 512′ of task region 540) (as indicated by the arrow in the figure), so as to avoid a situation in which the predicted moving path of the first robot and the predicted moving path of the second robot have overlapping segments.

It should be noted that, in response to the three embodiments described above all being performable by the first robot, the first robot can calculate the time required to perform the three embodiments, and perform the embodiment that corresponds to the shortest amount of time.

Moreover, according to another embodiment of the present invention, in response to the first robot having no other moving path able to bypass the task region 520, no other uncompleted task region, or has no way to avoid the current cleaning area of the second robot (e.g., if the task region is a long and narrow corridor and the two robots cannot move in a staggered manner), the first robot temporarily stops at its current position (as the grid 511 shown in FIG. 5D) until the second robot has completed the cleaning task of task region 520 and left the task region 520, and then the first robot may pass through the task region 520 to the next task region 530 to perform the next cleaning task.

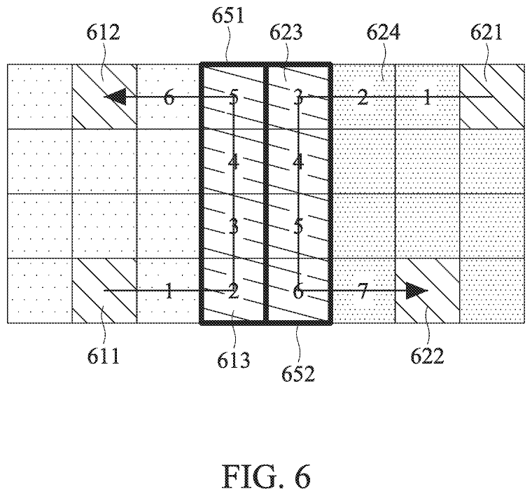

FIG. 6 is a schematic diagram illustrating a dodging strategy of a robot in accordance with another embodiment of the present invention. In this embodiment, the operating status of the first robot and the operating status of the second robot are both performing the cleaning task. As shown in FIG. 6, the first robot starts at the moving starting point 611, and moves along the direction indicated by the arrow in the figure to the moving terminal point 612. The second robot starts at the moving starting point 621, and moves along the direction indicated by the arrow in the figure to the moving terminal point 622. While according to the content of FIG. 6, the predicted moving path of the first robot and the predicted moving path of the second robot have adjacent segments (as the segment 651 and the segment 652 shown in the figure). Since the robot has a predetermined volume, a collision may occur when the two robots enter the adjacent segments simultaneously. In order to avoid a collision, the control terminal 110 or the leader robot will further determine whether the difference between the respective prediction time corresponding to the first robot and the second robot respectively entering region 450 is less than the given time. Each number shown in the grids in FIG. 6 is the corresponding prediction time of each position on the predicted moving path. In this embodiment, the first robot and the second robot start from its starting point simultaneously, while the first robot predicted to enter the adjacent segment 651 at the second timing point, and the second robot predicted to enter the adjacent segment 652 at the third timing point. Since the respective prediction time of the first robot and the second robot respectively entering the adjacent segments only differ by one second (less than the preset given time), and the moving directions of both are opposite, the robot entering the adjacent segment later will temporarily stop in front of the adjacent segment to avoid a collision of the two robots. For example, in this example, since the second robot enters the adjacent segment 652 later, the second robot will temporarily stop at the position of a previous grid of the grid 623 (i.e., grid 624), until the first robot has left the adjacent segment 651.

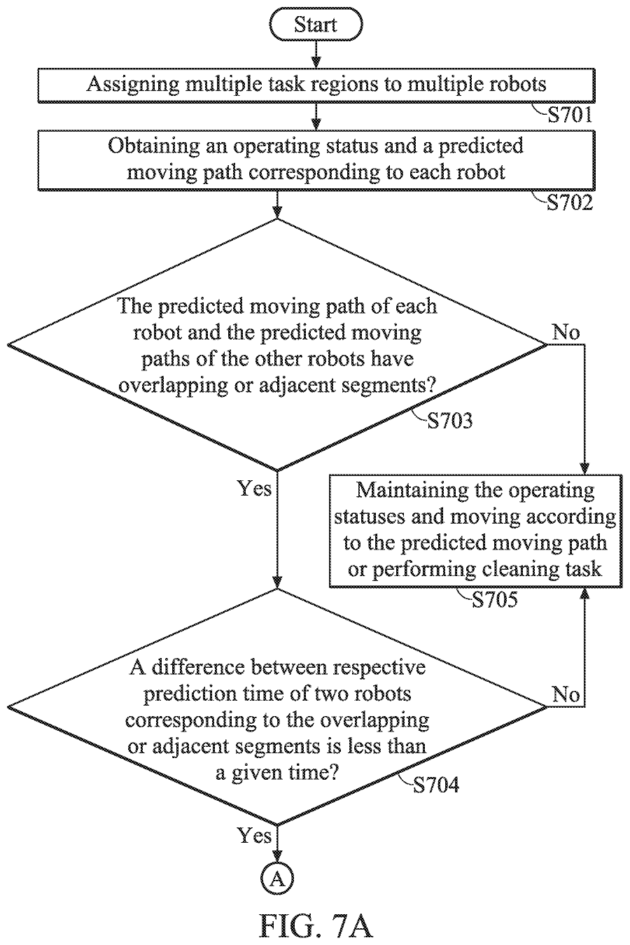

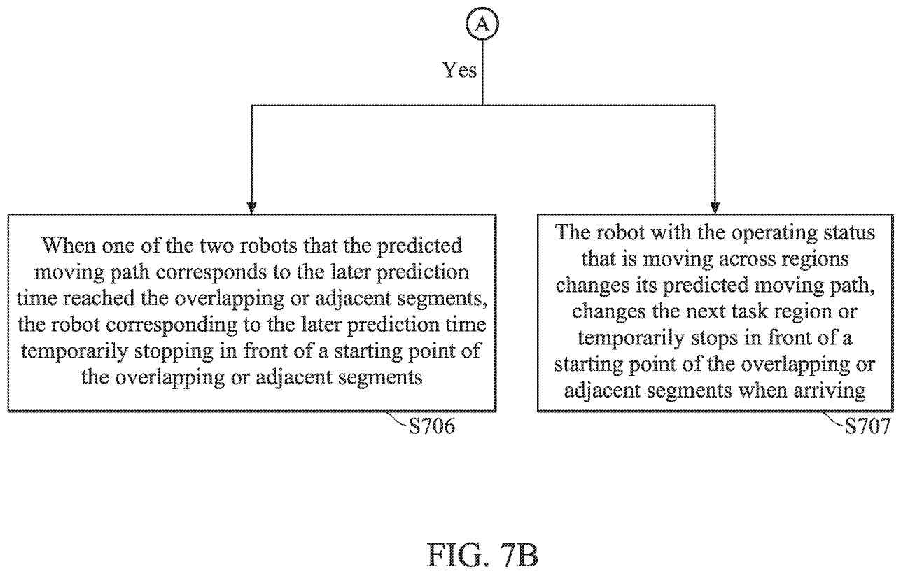

FIG. 7A to FIG. 7B are flowcharts illustrating a movement control method for multiple robots in accordance with an embodiment of the present invention. Firstly, in step S701, the control terminal 110 or the leader robot divides the task map into multiple task regions, and assigns the task regions to multiple robots. In step S702, each robot determines the operating status corresponding to each robot according to the task region and calculates the predicted moving path. In step S703, the control terminal 110 or the leader robot determines that whether the predicted moving path of each robot and the predicted moving path of other robot have overlapping segments or adjacent segments. In response to the predicted moving paths of two robots having overlapping segments or adjacent segments, the movement control method proceeds to step S704, the control terminal 110 or the leader robot further determines the difference between the respective prediction time of the two robots corresponding to the overlapping segments or the adjacent segments respectively is less than the given time. In response to the predicted moving paths of two robots do not having overlapping segments or adjacent segments, or in response to the difference between the respective prediction time of the two robots corresponding to the overlapping segments or the adjacent segments respectively being larger or equal to the given time, the movement control method proceeds to step S705, the two robots maintain the current operating statuses and move along the predicted moving paths or performing the current cleaning tasks.

Moreover, in response to the predicted moving paths having overlapping segments or adjacent segments and the difference between the respective prediction time of the two robots corresponding to the overlapping segments or the adjacent segments being less than the given time, the control terminal 110 or the leader robot further determines the corresponding operating statuses of the robots. While in response to the operating statuses of the two robots being both moving across regions or performing the cleaning tasks, the movement control method proceeds to step S706. In the step S706, when one of the two robots that the predicted moving path corresponds to the later prediction time reached the overlapping segments or adjacent segments, the robot corresponding to the later prediction time temporarily stops in front of a starting point of the overlapping segments or adjacent segments, until the distance from the other robot has reached a given distance or the other robot has entered the overlapping segments or adjacent segments for a given time. While in response to the operating statuses of the two robots being moving across regions and performing the cleaning task, respectively, the movement control method proceeds to step S707. In the step S707, the robot with the operating status that is moving across regions changes its original predicted moving path, changes the next task region or temporarily stops in front of the starting point of the overlapping segments or adjacent segments when arriving.

In the above exemplary apparatus, it should be noted that the present invention is not limited to the order of the steps and the order in which some steps are performed can differ from the other steps, or the other steps can be performed simultaneously, although the above method has been described using a series of steps or flowchart of blocks. Moreover, persons skilled in the art will appreciate that the steps shown in the flowchart are not exclusive, they may include other steps of the flowchart, or one or more steps may be deleted without affecting the scope of the present invention.

The method of the present invention, or a specific type or portion thereof, may exist in the form of code. The code can be included in physical medium such as a floppy disk, a CD, a hard disk, or any other machine readable (e.g., computer readable) storage medium, or a computer program product that is not limited to the external forms. When the code is loaded and executed by a machine, such as a computer, this machine becomes a device used to participate in the present invention. The code can also be transmitted through some transmission medium, such as a wire or a cable, fiber optics, or any transmission forms, wherein when the codes is received, loaded and executed by a machine, such as a computer, this machine becomes a device used to participate in the present invention. When implemented in a general purpose processing unit, the code combined with the processing unit provides an operation similar to a unique device of applying specific logic circuit.

As described above, according to the movement control method and method thereof for multiple robots in some embodiments of the present invention, in response to multiple robots in a task map, after receiving a predicted moving path of each robot and before two robots move to overlapping segments or adjacent segments, a control terminal or a leader robot can have one of the two robot performing appropriate dodge according to the corresponding prediction time of the robots, so as to avoid a collision of the two robots. Moreover, in response to the predicted moving path of the robot moving across the regions overlapping the predicted moving path of the robot performing a cleaning task, it will not affect the working efficiency of the robot performing the cleaning task by assigning the right to use the moving path to the robot performing the cleaning task in priority, or directly changing the predicted moving path of the robot moving across the regions.

The features of the embodiments described above make persons having ordinary skill in the art can clearly appreciate the form of the present specification. Persons having ordinary skill in the art can appreciate that the objectives and/or the advantages of the above embodiments can be accomplished in consistent with the above embodiments by designing or modifying other processes and structures based on the content of the present disclosure. Persons having ordinary skill in the art can also appreciate that the equivalent constructions without departing from the scope and spirit of the present invention can be modified, substituted or retouched without departing from the scope and spirit of the present invention.

What is claimed is:

1. A movement control method for multiple robots, comprising:
obtaining a first operating status and a first predicted moving path corresponding to a first robot;
obtaining a second operating status and a second predicted moving path corresponding to a second robot;
determining whether the first predicted moving path and the second predicted moving path have overlapping segments or adjacent segments;
in response to the first predicted moving path and the second predicted moving path having the overlapping segments or the adjacent segments, determining whether a difference between a first prediction time of the first robot and a second prediction time of the second robot, corresponding to the overlapping segments or the adjacent segments, is less than a given time; and
in response to the difference between the first prediction time and the second prediction time being less than the given time, changing a first movement status of the first robot or a second movement status of the second robot according to the first operating status and the second operating status.

2. The movement control method as claimed in claim 1, wherein the step of changing the first movement status of the first robot or the second movement status of the second robot according to the first operating status and the second operating status further comprises:
in response to the first operating status and the second operating status being both moving across regions, temporarily stopping the first robot or the second robot, corresponding to a later of the first prediction time and the second prediction time, in front of a starting point of the overlapping segments or the adjacent segments when the first robot or the second robot, corresponding to the later of the first prediction time and the second prediction time, reaches the overlapping segments or the adjacent segments;
wherein, the moving across regions is moving from one task region to another task region.

3. The movement control method as claimed in claim 2, further comprising:
in response to the first predicted moving path of the first robot or the second predicted moving path of the second robot, corresponding to the later of the first prediction time and the second prediction time, having been blocked, changing the first predicted moving path or the second predicted moving path.

4. The movement control method as claimed in claim 1, wherein the step of changing the first movement status of the first robot or the second movement status of the second robot according to the first operating status and the second operating status further comprises:
in response to the first operating status and the second operating status being both performing a cleaning task, temporarily stopping the first robot or the second robot, corresponding to a later of the first prediction time and the second prediction time, in front of a starting point of the overlapping segments or the adjacent segments when the first robot or the second robot, corresponding to the later of the first prediction time and the second prediction time, reaches the overlapping segments or the adjacent segments.

5. The movement control method as claimed in claim 1, wherein the step of changing the first movement status of the first robot or the second movement status of the second robot according to the first operating status and the second operating status further comprises:
in response to the first operating status being moving across regions and the second operating status being performing a cleaning task, changing the first predicted moving path of the first robot, changing a next task region of the first robot or temporarily stopping the first robot in front of a starting point of the overlapping segments or the adjacent segments when reaching the overlapping segments or the adjacent segments.

6. A movement control system for multiple robots, comprising:
a control terminal, comprising:
a first storage unit, storing a task map;
a first processing unit, configured to:
divide the task map into a plurality of task regions;
assign the plurality of task regions to a plurality of robots;
determine whether two of the robots have overlapping segments or adjacent segments according to an operating status and a predicted moving path of each of the robots;
in response to the two robots having the overlapping segments or the adjacent segments, determine whether a difference between respective prediction time of the two robots corresponding to the overlapping segments or the adjacent segments is less than a given time; and
in response to the difference between the respective prediction time of the two robots being less than the given time, output a control signal to change a movement status of one of the robots according to the operating statuses of the two robots;
wherein each of the robots comprises:
a second storage unit, storing the task region received from the control terminal;
a second processing unit, configured to:
determine the operating status according to the task map and generate the predicted moving path; and
change the movement status according to the control signal.

7. The movement control system as claimed in claim 6, wherein in response to the operating statuses of the two robots being both moving across regions, the second processing unit of the robot, corresponding to the later prediction time, temporarily stops the robot in front of a starting point of the overlapping segments or the adjacent segments when the robot that corresponds to the later prediction time reaches the overlapping segments or the adjacent segments; and
wherein the moving across regions is moving from one of the task regions to another.

8. The movement control system as claimed in claim 7, wherein in response to the predicted moving path of the robot, corresponding to the later prediction time, having been blocked, the second processing unit of the robot corresponding to the later prediction time changes the predicted moving path.

9. The movement control system as claimed in claim 6, wherein in response to the operating statuses of the two robots being both performing a cleaning task, the second processing unit of the robot, corresponding to the later prediction time, stops the robot in front of the overlapping segments or the adjacent segments when the robot reaches the overlapping segments or the adjacent segments.

10. The movement control system as claimed in claim 6, wherein in response to the operating statuses of the two robots being moving across regions and performing a cleaning task, respectively, the robot with the operating status that is moving across regions changes the corresponding predicted moving path, changes a next task region or temporarily stops in front of a starting point of the overlapping segments or the adjacent segments when reaching the overlapping segments or the adjacent segments.
